(19) United States
(12) Patent Application Publication
(10) Pub. No.: US 2007/0062049 A1
(43) Pub. Date: Mar. 22, 2007

(54) Pencil sharpener

(76) Inventor: Timothy Kern, Waukee, IA (US)

Correspondence Address: BRETT J. TROUT, PC, 516 WALNUT, DES MOINES, IA, 50309, US

(21) Appl. No.: 11/230,050

(22) Filed: Sep. 19, 2005

(51) Int. Cl. B43L 23/00

(52) U.S. Cl. 30/451

(57) ABSTRACT

An improved pencil sharpener assembly is provided for construction applications. The pencil sharpener assembly includes a retaining clip coupled to a pencil sharpener which discharges shavings outside and away from the housing of the pencil sharpener as a pencil is being sharpened. The retaining clip allows the sharpener assembly to be releasably coupled to a belt, a pocket, a toolbox or other item to allow one-handed use of the pencil sharpener. The pencil sharpener preferably directs shavings out of and away from the sharpener assembly to reduce cost, maintenance and weight, and to eliminate time associated with cleaning or emptying a pencil sharpener.

### BACKGROUND OF THE INVENTION

1. Field of the Invention

The present invention relates in general to a pencil sharpener and, more particularly, to a field operational pencil sharpener for use in construction applications.

2. Description of the Prior Art

It is known in the art to mount a pencil sharpener to a belt. U.S. Letters Patent No. 698,100 teaches the releasable attachment of a contractor's pencil sharpener to a retainer mounted on a plate which, in turn, is attached to a tool belt. One drawback associated with such prior art devices is the requirement of a bulky, expensive fixture to releasably attach the pencil sharpener. The attachment mechanism is typically riveted or otherwise secured to a dedicated contractor's tool belt or the like. Accordingly, it is difficult to utilize the pencil sharpener without the associated, dedicated retainer. It would be desirable to provide a pencil sharpener which is light, inexpensive and can be easily utilized by a worker without the requirement of expensive or bulky attachment mechanisms.

It is also known in the art to provide a pencil sharpener attached to a tape measure or the like. Typically, the tape measure includes a spring clip or other mechanism for releasably attaching the clip to a belt. While this mechanism overcomes the necessity of a dedicated belt and/or retainer, and allows the pencil sharpener/tape measure to be connected to a plurality of different items, the resulting product is still unnecessarily bulky, heavy and expensive for many applications. It would be desirable to provide a low-cost, lightweight pencil sharpener which can be easily secured to a plurality of materials.

The drawbacks associated with the prior art noted hereinabove are substantially eliminated by the present invention.

### SUMMARY OF THE INVENTION

The present invention provides a pencil sharpener coupled to a retainer. The pencil sharpener includes a housing defining a centering aperture and retainer. Means are coupled to the housing for sharpening a pencil and directing shavings from inside the retainer out of the pencil sharpener. The retainer comprises a first portion coupled to the housing, a second portion, and resilient means coupled between the first portion and the second portion for biasing the second portion toward the housing. In the preferred embodiment, the pencil sharpener is small and lightweight, and the retainer is a steel spring clip attached thereto, to allow the assembly to be releasably connected to a contractor's tool belt or the like.

### BRIEF DESCRIPTION OF THE DRAWINGS

The present invention will now be described, by way of example, with reference to the accompanying drawings in which:

FIG. 1 illustrates a side perspective view of the improved pencil sharpener of the present invention;

FIG. 2 illustrates a side perspective view of the opposite side of the pencil sharpener of FIG. 1;

FIG. 3 illustrates a side elevation of the pencil sharpener of FIG. 1 coupled to a belt and sharpening a pencil; and

FIG. 4 illustrates an alternative embodiment of the present invention incorporating a contractor's pencil sharpener.

### DETAILED DESCRIPTION OF THE PREFERRED EMBODIMENT

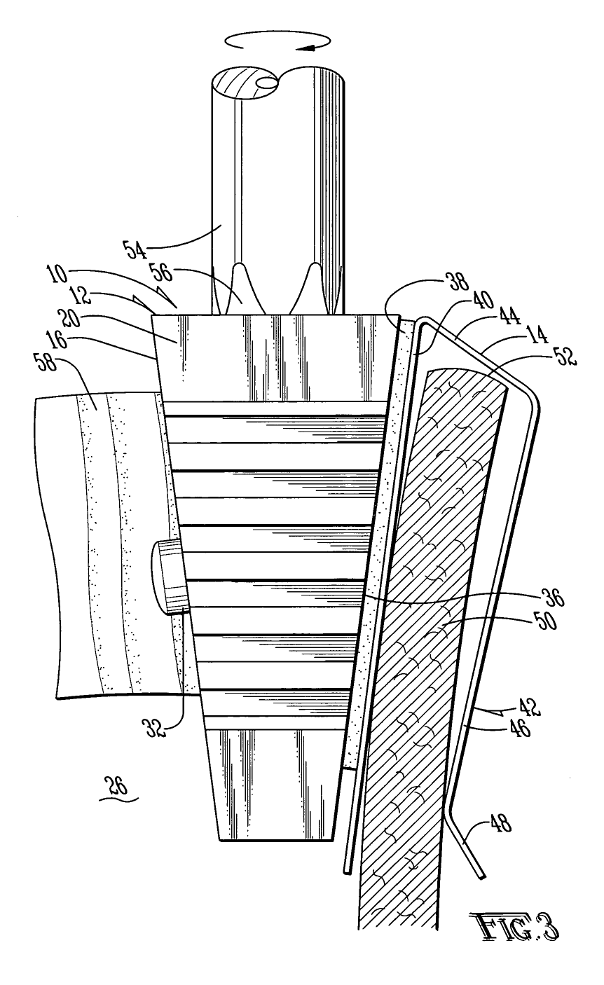

With reference to the drawings, a pencil sharpener assembly is indicated generally as (10). The assembly (10) includes a pencil sharpener (12) and a retaining clip (14). As shown in FIG. 2, the pencil sharpener (12) includes a housing (16). While the housing (16) may be constructed of any suitable materials, and of any desired configuration, in the preferred embodiment the housing (16) is approximately within twenty percent of the following measurements: 1⅜ inches long, ⅞ inches wide, and ¾ inches thick at the thickest point. The housing (16) is preferably injection molded of a strong, lightweight plastic material, but may be die cast of aluminum alloy or other metal. The housing (16) is preferably molded with serrations (18) or the like in the sides (20) of the housing (16) to provide a gripping surface and assist in mounting the assembly (10) as described in more detail below.

The housing (16) is preferably molded so as to define a pencil centering aperture (22) and a pencil point retainer (24). The retainer (24) is preferably in fluid communication with the exterior (26) through a passageway (28). The passageway (28) is partially covered by a blade (30). The blade (30) is secured to the housing (16) by a screw (32) passing into the exterior face (34) of the housing (16).

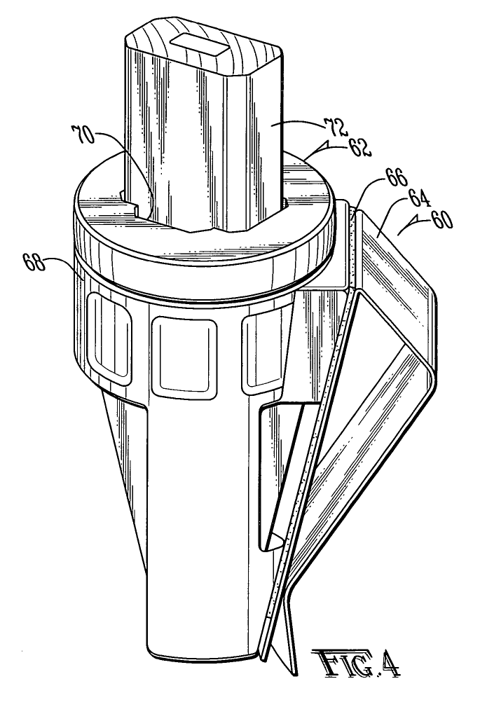

As shown in FIG. 3, the retaining clip (14) is secured to the interior face (36) using adhesive (38). The retaining clip (14) may instead be secured using screws (not shown) or the like. The retaining clip (14) includes a first portion (40) secured to the housing (16), and a second portion (42). Although the first portion (40) and second portion (42) are a single integrated piece of spring steel, the second portion (42) includes a shoulder or hinge portion (44) coupled to a pinching or retaining portion (46) and terminating in a diverter (48). Although the pencil sharpener assembly (10) may be any suitable dimensions, in the preferred embodiment the assembly (10) is preferably provided with no dimension greater than 3.0 inches, and most preferably provided with no dimension greater than 2.0 inches. The assembly (10) is preferably less than one hundred grams, more preferably less than fifty grams, and most preferably less than thirty grams.

When it is desired to utilize the pencil sharpener assembly (10) of the present invention, the assembly (10) is positioned relative to a contractor's tool belt (50), or the like, with the interior face (36) of the housing (16) facing the belt (50). The pencil sharpener assembly (10) is thereafter pushed downward onto the belt (50) sufficiently to cause the diverter (48) of the retaining clip (14) to bias the retaining portion (46) of the retaining clip (14) until the hinged portion (44) of the retaining clip (14) contacts the top (52) of the belt (50). Although the pencil sharpener assembly (10) is preferably coupled to a belt (50), the assembly (10) may instead be coupled to a pocket, a sleeve, a toolbox, or any other desired item.

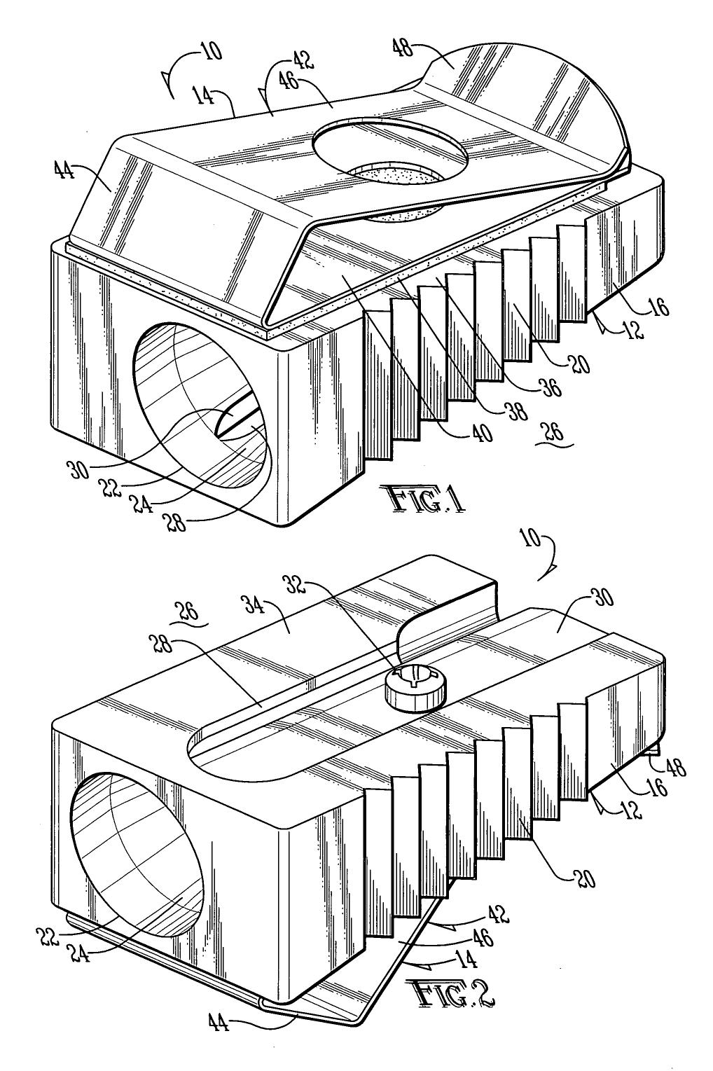

When it is desired to sharpen a pencil (54) the tip (56) of the pencil (54) is inserted into the aperture (22) of the housing (16). (FIGS. 1 and 3). The pencil (54) is then turned relative to the housing (16), causing the tip (56) of the pencil (54) to move across the blade (30). As the tip (56) of the pencil (54) rotates against the blade (30), the blade (30) cuts shavings (58) from the pencil (54), which exit the retainer (24) through the passageway (28) to the exterior (26). Although the pencil sharpener assembly (10) may be provided with means (not shown) for retaining the shavings (58), in the preferred embodiment the shavings (58) are allowed to exit the housing (56).

Shown in FIG. 4 is an alternate sharpener assembly (60), incorporating a contractor type sharpener (62), such as those well known in the art, coupled to a modified retaining clip (64). The modified retaining clip (64) is coupled to the contractor sharpener (62) by adhesive (66). As shown in FIG. 4, the contractor sharpener (62) includes a housing (68) defining a plurality of apertures (70), sized to accommodate various sizes of contractor pencils (72). The contractor pencils (72) are sharpened in a manner similar to that described above in association with the main embodiment.

Although the invention has been described with respect to a preferred embodiment thereof, it is to be understood that it is not to be so limited, since changes and modifications can be made therein which are within the full, intended scope of this invention as defined by the appended claims. For example, it is anticipated that the pencil sharpener assembly (10) may be constructed of any suitable material and of any desired configuration.

What is claimed is:

1. A pencil sharpener assembly comprising:
(a) a pencil sharpener comprising:
(i) a housing defining a centering aperture and a retainer;
(ii) means coupled to said housing for sharpening a pencil and directing shavings from inside said retainer out of said pencil sharpener;
(b) a retainer coupled to said pencil sharpener, said retainer comprising:
(i) a first portion coupled to said housing;
(ii) a second portion;
(iii) resilient means coupled between said first portion and said second portion for biasing said second end toward said housing.

2. The pencil sharpener of claim 1, wherein said retainer is a spring.

3. The pencil sharpener of claim 2, wherein said spring is substantially flat.

4. The pencil sharpener of claim 2, wherein said spring comprises a first end coupled to said housing, a pincher, and a shoulder biasing said pincher toward said housing.

5. The pencil sharpener of claim 4, wherein said spring further comprises a diverter coupled to said pincher.

6. The pencil sharpener of claim 2, wherein said spring is coupled to said housing, extends away from said housing and angles back toward said housing toward a pincher sufficiently to define an inner spring space.

7. The pencil sharpener of claim 6, wherein said spring further comprises a diverter coupled to said pincher.

8. The pencil sharpener of claim 1, wherein said pencil sharpener assembly has no straight line dimension greater than seven centimeters.

9. The pencil sharpener of claim 8, wherein said pencil sharpener assembly weighs less than one hundred grams.

10. The pencil sharpener of claim 1, wherein said pencil sharpener assembly weighs less than one hundred grams.

11. The pencil sharpener of claim 1, wherein said sharpening means comprises means for directing shavings away from said pencil sharpener assembly.

12. A pencil sharpener comprising:
(a) a pencil sharpener comprising:
(i) a housing defining a centering aperture and a point retainer;
(ii) a blade angled and coupled to said housing in a manner which directs pencil shavings from said point retainer away from said pencil sharpener;
(b) a spring coupled to said housing, said spring comprising:
(i) a first end coupled to said housing;
(ii) a shoulder angled away from and back toward said housing sufficiently to define an inner spring space; and
(iii) a pincher coupled to said shoulder

13. The pencil sharpener of claim 12, wherein said spring comprises a first end coupled to said housing, a pincher, and a shoulder biasing said pincher toward said housing.

14. The pencil sharpener of claim 12, wherein said blade defines an opening to said point retainer.

15. The pencil sharpener of claim 12, wherein said pencil sharpener assembly has no straight line dimension greater than five centimeters.

16. The pencil sharpener of claim 12, wherein said pencil sharpener assembly weighs less than thirty grams.

17. A pencil sharpener assembly comprising:
(a) a pencil sharpener comprising:
(i) a housing defining a point retainer;
(ii) means coupled to said housing for shaving a pencil and diverting pencil shavings away from said pencil sharpener assembly;
(b) a spring coupled to said housing, said spring comprising:
(i) a first end coupled to said housing;
(ii) a shoulder coupled to said first end, said shoulder extending away from and back toward said housing;
(iii) a pincher coupled to said shoulder; and
(iv) means coupled to said pincher for diverting said pincher away from said housing in response to the application of pressure to said diverting means.

18. The pencil sharpener assembly of claim 17, wherein said shaving means is a flat blade.

19. The pencil sharpener assembly of claim 17, wherein said first end, said shoulder, said pincher and said diverting means are substantially flat.

20. The pencil sharpener assembly of claim 17, wherein said pencil sharpener weighs less than 30 grams.
